(19) United States
(12) Patent Application Publication
(10) Pub. No.: US 2026/0258168 A1
(43) Pub. Date: Sep. 3, 2026

(54) RESIN COMPOSITION, OPTICAL ELEMENT, OPTICAL DEVICE, IMAGING DEVICE, CURED PRODUCT, AND METHOD OF PRODUCING OPTICAL ELEMENT

(71) Applicant: CANON KABUSHIKI KAISHA, Tokyo (JP)

(72) Inventor: KEI TAGAMI, Kanagawa (JP)

(21) Appl. No.: 19/547,480

(22) Filed: Feb. 23, 2026

(30) Foreign Application Priority Data
Mar. 3, 2025 (JP) 2025-033069

(51) Int. Cl. C08F 20/36; B29D 11/00; C08F 2/00; G02B 1/04; H04N 23/55

(52) U.S. Cl. CPC C08F 20/36; B29D 11/00403; B29D 11/00442; C08F 2/001; G02B 1/041; H04N 23/55

(57) ABSTRACT

A resin composition includes a urethane (meth)acrylate (A), a monofunctional (meth)acrylate (B) having an alicyclic skeleton represented by any of Formulae (1) to (3), and a polymer (C) of a monofunctional (meth)acrylate monomer (c1) having an alicyclic skeleton represented by any of Formulae (1) to (3). A content of the polymer (C) is 15 parts by mass or less with respect to 100 parts by mass of the resin composition.

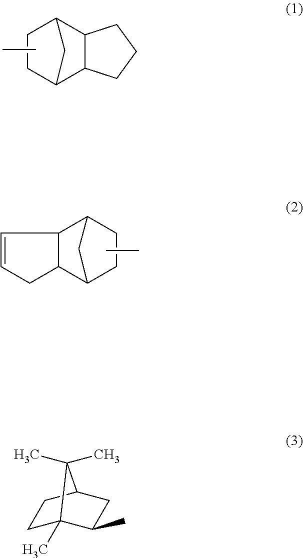

### BACKGROUND

### Field of the Technology

The present disclosure relates to a resin composition, an optical element, an optical device, an imaging device, a cured product, and a method of producing an optical element.

### Description of the Related Art

A lens in which a cured product of a resin composition is provided on a transparent base material such as glass is known as an optical element. Such a lens is produced by providing a resin composition between a base material and a molding die and polymerizing or copolymerizing the resin composition using the molding die to form a cured product having a desired shape on a surface of the base material. The lens produced by such a production method is referred to as a replica element. The replica element is capable of easily forming a desired surface shape, and thus is effectively used as an aspherical lens or a Fresnel lens. The aspherical lens is a general term for a lens having a curvature that continuously changes from the center over the periphery of the lens.

A cured product of a resin composition used for the replica element is required to have low water absorption and toughness. Japanese Patent Laid-Open No. 2012-46566 discloses an electron beam-curable composition formed of, as a material with a low water absorption rate, a compound containing a urethane (meth)acrylate, an alicyclic skeleton, and one (meth)acryloyl group.

However, the cured product of the resin composition containing a urethane (meth)acrylate disclosed in Japanese Patent Laid-Open No. 2012-46566 is required to have improved water absorbency. An increase in the mass ratio of a (meth)acrylate having an alicyclic skeleton results in a decrease in the water absorption rate, but also leads to a decrease in the toughness, and thus achievement of both the toughness and the low water absorption rate has been a disadvantage.

### SUMMARY

In consideration of the above-described disadvantage, the present disclosure provides a resin composition in which the toughness and the low water absorption rate has been achieved.

According to an aspect of the present disclosure, there is provided a resin composition including: a urethane (meth)acrylate (A); a monofunctional (meth)acrylate (B) having an alicyclic skeleton represented by any of Formulae (1) to (3); and a polymer (C) of a monofunctional (meth)acrylate monomer (c1) having an alicyclic skeleton represented by any of Formulae (1) to (3), in which a content of the polymer (C) is 15 parts by mass or less with respect to 100 parts by mass of the resin composition.

According to a second aspect of the present disclosure, there is provided a resin composition including: a urethane (meth)acrylate (A); a monofunctional (meth)acrylate (B) having an alicyclic skeleton represented by any of Formulae (1) to (3); and a polymer (C) of a monofunctional (meth)acrylate monomer (c1) having an alicyclic skeleton represented by any of Formulae (1) to (3), in which a cured product of the resin composition has a water absorption rate of 0.50% or less.

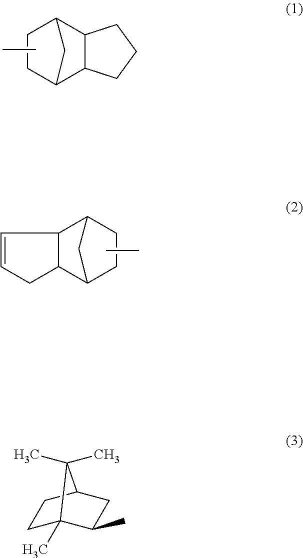

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view showing an optical element according to an embodiment of the present disclosure.

FIGS. 2A and 2B are schematic views showing a method of producing an optical element according to an embodiment of the present disclosure.

FIG. 3 is a schematic view showing an imaging device according to an embodiment of the present disclosure.

### DESCRIPTION OF THE EMBODIMENTS

Hereinafter, embodiments of the present disclosure will be described.

### Optical Element

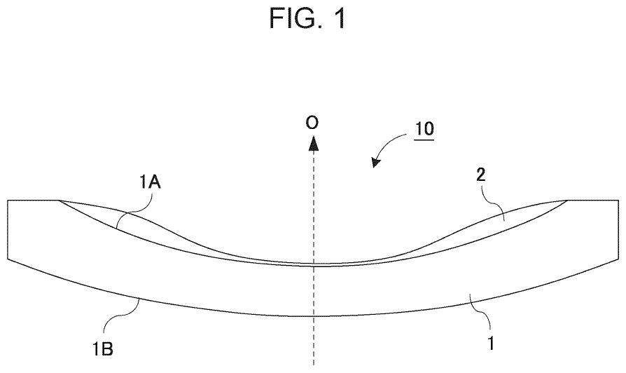

FIG. 1 is a schematic view showing an optical element according to an embodiment of the present disclosure, and is a side cross-sectional view of an optical element 10 cut in a lamination direction along a straight line passing through an element center O of the optical element.

The optical element 10 of FIG. 1 includes a transparent base material 1 and a cured product 2. The optical element 10 is an optical element of a type that is referred to as a replica lens in which a cured product is provided on the transparent base material 1.

### Transparent Base Material 1

The transparent base material 1 has a first surface 1A and a second surface 1B as optical surfaces. The first surface 1A of the transparent base material 1 is either a light incident surface or a light emitting surface, and the second surface 1B of the transparent base material 1 is the other of the light incident surface or the light emitting surface.

The transparent base material 1 can be made of a transparent resin or transparent glass. In the present specification, the term “transparent” denotes that the transmittance of light having a wavelength range of 400 nm or greater and 780 nm or less is 10% or greater. The transparent base material 1 can be made of glass, for example, typical optical glass such as silicate glass, borosilicate glass, or phosphate glass, quartz glass, or glass ceramics.

In FIG. 1, the first surface 1A has a concave spherical shape, and the second surface 1B has a convex spherical shape, but the shape of the transparent base material 1 is not particularly limited. The shape of the surface of the transparent base material 1 that is in contact with the cured product 2 can be selected from a concave spherical surface, a convex spherical surface, an axisymmetric aspherical surface, and a flat surface depending on the desired characteristics thereof. The transparent base material 1 can have a circular shape when viewed from above the paper surface of FIG. 1. This is because the assembly accuracy is improved when the optical element 10 is used as a lens in an optical system described below.

### Cured Product 2

The cured product 2 is provided in close contact with the first surface 1A of the transparent base material. The cured product 2 is a cured product formed by curing the resin composition of the present disclosure, which is obtained by polymerizing or copolymerizing the resin composition of the present disclosure.

The water absorption rate of the cured product 2 can be 0.50% or less, or less than 0.50% from the viewpoint of reducing fluctuations in optical characteristics due to the water absorption rate. When the water absorption rate of the cured product 2 is greater than 0.50%, a change in surface shape of the cured product 2 before and after water absorption is large, and the image quality may fluctuate in a case where the optical element is used in the optical system. Therefore, the water absorption rate of the cured product 2 can be 0.40% or less, or 0.32% or less.

In FIG. 1, the thickness of the cured product 2 is not uniform in the plane of the first surface 1A. That is, the shape of the surface of the cured product 2 that is not in contact with the transparent base material 1 is aspherical. In the present embodiment, the thickness is distributed such that the cured product 2 has a minimum thickness d1 in the vicinity of the element center O and a maximum thickness d2 at a peripheral edge portion of the element, but the shape is not necessarily limited thereto. For example, the thickness may be distributed such that the cured product 2 has the maximum thickness d2 in the vicinity of the element center O and the minimum thickness d1 at the peripheral edge portion of the element. The ratio of the maximum thickness d2 to the minimum thickness d1 of the cured product 2 can be greater than 1 and 30 or less. When the ratio of the maximum thickness d2 to the minimum thickness d1 of the cured product 2 is greater than 30, since a difference in thickness of the cured product 2 is large, the surface accuracy may not be maintained high in a case of curing shrinkage. The ratio of the maximum thickness d2 to the minimum thickness d1 of the cured product 2 can be 8 or greater. Further, the minimum thickness d1 can be 300 μm or less, and the maximum thickness d2 can be 10 μm or greater and 1,000 μm or less.

### Resin Composition

The resin composition contains a urethane (meth)acrylate (A), a monofunctional (meth)acrylate (B) having an alicyclic skeleton represented by any of Formulae (1) to (3), and a polymer (C) of a monofunctional (meth)acrylate monomer (c1) having an alicyclic skeleton represented by any of Formulae (1) to (3). The resin composition may further contain a polymerization initiator (D).

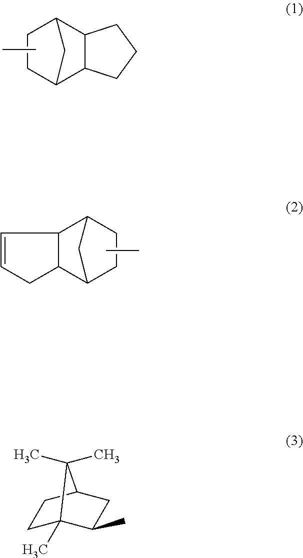

A component (A) is a urethane (meth)acrylate. The component (A) plays a role in improving the toughness. Therefore, the cured product 2 is suppressed from cracking in an environmental resistance test such as a temperature cycle test.

From the viewpoint of low water absorption, the component (A) can be a urethane (meth)acrylate having an alicyclic skeleton, such as a urethane (meth)acrylate synthesized from an isocyanate having an alicyclic skeleton. Further, from the viewpoint of achieving both low water absorption and toughness, the component (A) can be a bifunctional urethane (meth)acrylate. The component (A) can be synthesized from, for example, an isocyanate, a diol such as a polydiol or a polycarbonate, and a hydroxyl group-containing (meth)acrylate.

The component (A) may be a urethane (meth)acrylate which is a reactant of a diol such as a polycarbonate diol or a polyester diol, an organic diisocyanate, and a hydroxyl group-containing (meth)acrylate.

Examples of the component (A) include a compound obtained by reacting a diol with an organic diisocyanate to produce an isocyanate group-containing compound and reacting this compound with a hydroxyl group-containing (meth)acrylate, and a compound obtained by reacting a diol, an organic diisocyanate, and a hydroxyl group-containing (meth)acrylate at the same time. Among these, the former compound can be suitably used from the viewpoint of easily controlling the molecular weight.

Both an oligomer and a polymer can be used as the component (A), and the weight-average molecular weight thereof can be 1,000 or greater and 50,000 or less, or 5,000 or greater and 20,000 or less. The weight-average molecular weight of the component (A) is a value obtained by measuring the molecular weight by gel permeation chromatography (GPC) in terms of polystyrene.

Among diols, examples of the polycarbonate diol include reactants of a low-molecular-weight diol, a polyether diol, and/or bisphenol such as bisphenol A, ethylene carbonate, and dialkyl carbonate such as dibutyl carbonate.

Here, examples of the low-molecular-weight diol include ethylene glycol, propylene glycol, cyclohexanedimethanol, 3-methyl-1,5-pentanediol, 1,5-pentanediol, and 1,6-hexanediol.

Examples of the polyether diol include diols of polyalkylene glycol such as polyethylene glycol, polypropylene glycol, and polytetramethylene glycol, and diols of block or random polymers such as a polyethylene polypropoxy block polymer diol.

Among diols, examples of the polyester diols include esterification reactants of low-molecular-weight diols and/or polyether diols with acid components such as dibasic acids such as adipic acid, succinic acid, phthalic acid, tetrahydrophthalic acid, hexahydrophthalic acid, and terephthalic acid, or anhydrides thereof.

Examples of the organic diisocyanate include aliphatic diisocyanates such as hexamethylene diisocyanate, lysine methyl ester diisocyanate, 2,4,4-trimethylhexamethylene diisocyanate, and dimer acid diisocyanate, diisocyanates having an alicyclic skeleton, such as isophorone diisocyanate, 4,4′-methylenebis(cyclohexyl isocyanate), and @,@′-diisocyanate dimethylcyclohexane, aliphatic diisocyanates having an aromatic ring, such as xylylene diisocyanate and tetramethyl xylylene diisocyanate, aromatic diisocyanates such as p-phenylene diisocyanate, tolylene diisocyanate, 4,4′-diphenylmethane diisocyanate, naphthalene-1,5-diisocyanate, and tolidine diisocyanate, and mixtures of two or more kinds thereof. Among these compounds, diisocyanates having an alicyclic skeleton can be used, and isophorone diisocyanate can be suitably used.

Examples of the hydroxyl group-containing (meth)acrylate include hydroxyalkyl (meth)acrylates such as 2-hydroxyethyl (meth)acrylate, 2-hydroxypropyl (meth)acrylate, hydroxybutyl (meth)acrylate, hydroxypentyl (meth)acrylate, hydroxyhexyl (meth)acrylate, hydroxyoctyl (meth)acrylate, pentaerythritol tri-, di-, or mono(meth)acrylate, and trimethylol propane di- or mono(meth)acrylate.

Examples of a commercially available product of the component (A) include UN-9000PEP and UN-9200A (both manufactured by Negami Chemical Industrial Co., Ltd.).

The component (A) may be used alone or in combination of two or more kinds thereof depending on the viscosity, the curing shrinkage rate, the water absorption rate, the optical characteristics, and the like during molding of the cured product 2.

The content of the component (A) can be 50 parts by mass or greater and 80 parts by mass or less with respect to 100 parts by mass of the resin composition, 60 parts by mass or greater and 70 parts by mass or less from the viewpoints of the toughness and the compatibility, or 60 parts by mass or greater and 65 parts by mass or less from the viewpoint of the water absorbency.

### Component (B)

A component (B) is a monofunctional (meth)acrylate having an alicyclic skeleton represented by any of Formulae (1) to (3). The component (B) plays a role in imparting low water absorption.

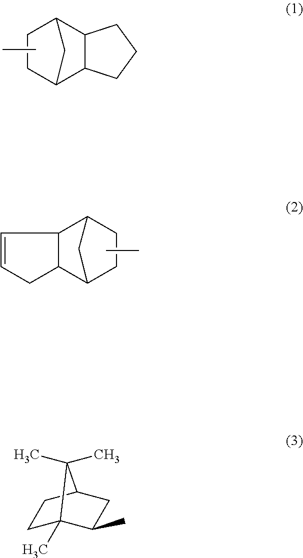

The alicyclic skeleton represented by Formula (1) is a tricyclodecane skeleton. The alicyclic skeleton represented by Formula (2) is a dicyclopentenyl skeleton. The alicyclic skeleton represented by Formula (3) is an isobornyl skeleton.

The component (B) is not particularly limited, but can be a compound represented by any of Formulae (1a) to (3a). In Formulae (1a) to (3a), R₁ to R₃ represent a hydrogen atom or a methyl group.

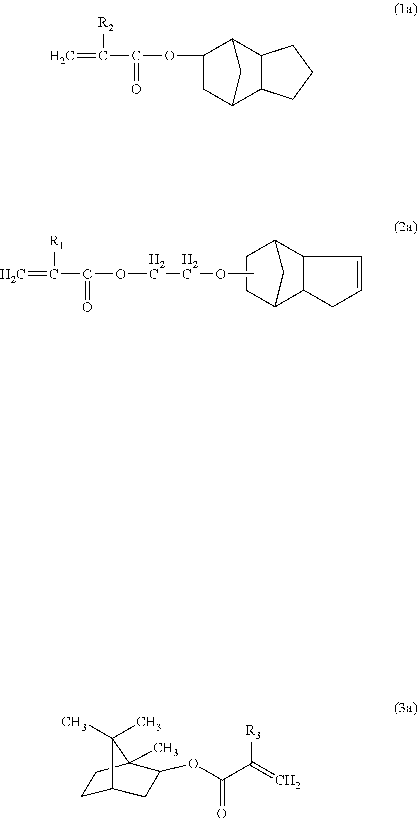

Examples of a commercially available product of the component (B) include FANCRYL Series FA-512M (dicyclopentenyloxyethyl methacrylate) and FA-513M (dicyclopentamethacrylate) (both manufactured by Resonac Holdings Corporation), Isobornyl Methacrylate and Isobornyl Acrylate (both manufactured by Tokyo Chemical Industry Co., Ltd.), and IB-X (isobornyl methacrylate) and IB-XA (isobornyl acrylate) (both manufactured by KYOEISHA CHEMICAL CO., LTD.).

The component (B) may be used alone or in combination of two or more kinds thereof depending on the viscosity, the curing shrinkage rate, the water absorption rate, the optical characteristics, and the like during molding of the cured product 2.

The content of the component (B) can be 12 parts by mass or greater and 45 parts by mass or less, or 22 parts by mass or greater and 35 parts by mass or less with respect to 100 parts by mass of the resin composition from the viewpoints of the toughness and the water absorbency.

### Component C

The component (C) is a polymer of a monofunctional (meth)acrylate monomer (c1). The monofunctional (meth)acrylate monomer (c1) has an alicyclic skeleton represented by any of Formulae (1) to (3). The component (C) has an alicyclic skeleton represented by any of Formulae (1) to (3), but the polymer having an alicyclic skeleton represented by any of Formulae (1) to (3) has a low water absorption rate.

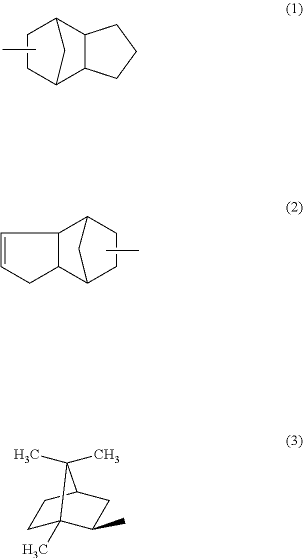

The component (C) plays a role in imparting the toughness and the low water absorption. The present inventors have considered that the mechanism by which the toughness and the low water absorption rate are achieved is as follows. The component (A) has an effect of improving the toughness, but acts to increase the water absorption rate, while the component (B) has an effect of decreasing the water absorption rate, but acts to decrease the toughness. Therefore, it is difficult to decrease the water absorption rate while maintaining the toughness using the two components of the component (A) and the component (B). The component (C) has an effect of decreasing the water absorption rate as a monomer and exhibits toughness higher than the toughness of the monomer when polymerized. Therefore, it is considered that the water absorption rate can be decreased while the toughness is maintained by adding the component (C) to the component (A) and the component (B).

The monofunctional (meth)acrylate monomer (c1) is not particularly limited, but a compound represented by any of Formulae (1a) to (3a) can be used. In Formulae (1a) to (3a), R₁ to R₃ represent a hydrogen atom or a methyl group.

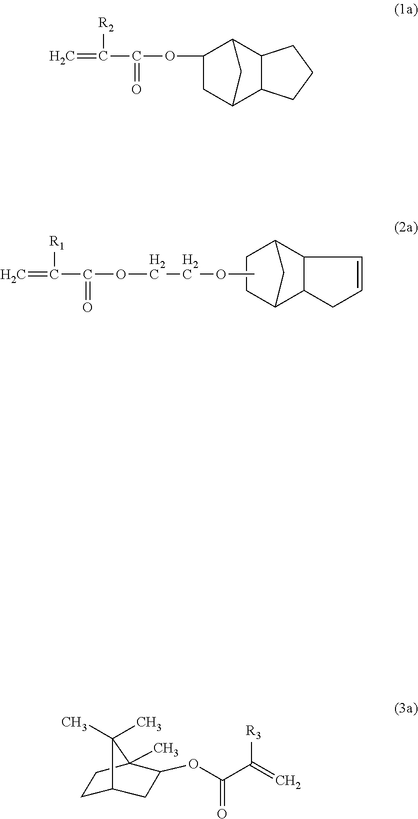

From the viewpoint of the compatibility, the monofunctional (meth)acrylate monomer (c1) can be the same compound as the monofunctional (meth)acrylate (B).

Examples of a commercially available product of the monofunctional (meth)acrylate monomer (c1) are the same as those for the component (B).

The component (C) may be used alone or in combination of two or more kinds thereof depending on the viscosity, the curing shrinkage rate, the water absorption rate, the optical characteristics, and the like during molding of the cured product 2.

The weight-average molecular weight (Mw) of the component (C) can be 35,000 or greater and 300,000 or less. The cured product 2 maintains the toughness and the water absorption rate is decreased when the weight-average molecular weight of the component (C) is in the above-described range. However, the toughness may be insufficient when the weight-average molecular weight thereof is less than 35,000. Further, the compatibility of the component (C) with the component (A) and the component (B) may be insufficient when the weight-average molecular weight thereof is greater than 300,000. Here, the weight-average molecular weight of the component (C) is a value in terms of polymethyl methacrylate, and can be measured by, for example, gel permeation chromatography (GPC). More specifically, first, a calibration curve is created from the elution time and the weight-average molecular weight using a polymethyl methacrylate resin that has a known monodisperse weight-average molecular weight and is available as a reagent, and an analytical gel column that elutes high-molecular weight components first. Further, the weight-average molecular weight (Mw) can be determined based on the obtained calibration curve.

The content of the component (C) can be 15 parts by mass or less with respect to 100 parts by mass of the resin composition from the viewpoint of the compatibility, or 3 parts by mass or greater and 10 parts by mass or less with respect to 100 parts by mass of the resin composition from the viewpoint of the toughness. When the content of the component (C) is greater than 15 parts by mass, the compatibility of the component (C) with the resin composition is decreased, and as a result, the handleability may be degraded.

### Component (D)

A component (D) is a polymerization initiator. The resin composition may contain the component (D). When the resin composition contains the component (D), the unreacted polymerization initiator may remain in the cured product 2.

The component (D) may be a photopolymerization initiator or a thermal polymerization initiator, which can be determined by the production process to be selected. However, when replica molding is performed to produce an aspherical shape, the component (D) can be a photopolymerization initiator from the viewpoint of a high curing speed.

Examples of a commercially available product of the photopolymerization initiator include 2-benzyl-2-dimethylamino-1-(4-morpholinophenyl)-1-butanone, 1-hydroxycyclohexyl phenyl ketone, bis(2,4,6-trimethylbenzoyl)-phenylphosphine oxide, 4-phenylbenzophenone, 4-phenoxybenzophenone, 4,4′-diphenylbenzophenone, and 4,4′-diphenoxybenzophenone.

The content of the component (D) can be 0.01 parts by mass or greater and 10 parts by mass or less with respect to 100 parts by mass of the resin composition. The reactivity may not be sufficiently obtained when the content of the component (D) is less than 0.01 parts by mass, and the transmittance of the cured product 2 may be decreased when the content thereof is greater than 10 parts by mass.

### Other Components

A polymerization inhibitor, an oxidation inhibitor, a light stabilizer (HALS), an ultraviolet absorbing agent, a silane coupling agent, a release agent, a pigment, a dye, or the like may be added to the resin composition as necessary.

### Method of Producing Optical Element

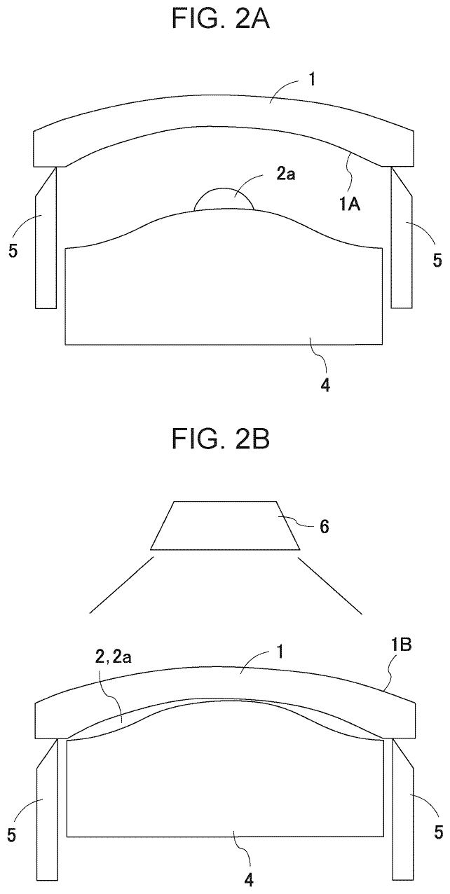

A method of producing an optical element of the present embodiment is not particularly limited, and an example of a suitable production step will be described. FIGS. 2A and 2B are schematic views showing a method of producing an optical element according to an embodiment of the present disclosure.

First, a transparent base material 1 and a resin composition 2a are prepared (preparation step).

The first surface 1A of the transparent base material 1 can be subjected to a pretreatment in order to improve the adhesion between the transparent base material 1 and the cured product 2. When the transparent base material 1 is glass, for example, a silane coupling treatment, a corona discharge treatment, a UV ozone treatment, or a plasma treatment can be selected as the pretreatment. From the viewpoint of further enhancing the adhesion by directly chemically bonding the cured product 2 to the first surface 1A, a coupling treatment can be performed using a silane coupling agent. Specific examples of the coupling agent include 3-methacryloxypropylmethyldimethoxysilane, 3-methacryloxypropyltrimethoxysilane, 8-methacryloxyoctyltrimethoxysilane, 3-acryloxypropyltrimethoxysilane, 3-methacryloxypropylmethyldiethoxysilane, and 3-methacryloxypropyltriethoxysilane.

A method of obtaining the resin composition 2a is not particularly limited. For example, first, the component (C) is obtained by performing a polymerization step of polymerizing the monofunctional (meth)acrylate monomer (c1). The conditions for polymerization are not particularly limited, but the heating temperature can be set to 80° C. or lower due to the possibility that the molecular weight of the polymer is decreased when the temperature of the polymerization is increased. The lower limit of the temperature is not particularly limited, but can be set to 50° C. or higher from the viewpoint of not making the process time excessively long. Next, the resin composition 2a can be obtained by performing a mixing step of mixing the component (C), the component (A), the component (B), and as necessary, the component (D). A method or time for mixing the components is not particularly limited, but the components can be uniformly mixed.

Next, the resin composition 2a is added dropwise onto a mold 4 as shown in FIG. 2A. In the present embodiment, the resin composition 2a is an ultraviolet-curable composition containing a photopolymerization initiator. The transparent base material 1 is placed on an ejector 5 to be disposed at a position facing the mold 4. The mold 4 is a metal mold that has, for example, a surface having an inverted shape of a desired aspherical shape and can be prepared by performing NiP plating or oxygen-free copper plating on a metal parent material such as a stainless steel material or a steel material and cutting the material with a precision working machine. Further, the surface of the mold 4 may be coated with a release agent to control the releasability of the resin. The type of the release agent is not particularly limited, and examples thereof include a fluorine coating agent.

Next, as shown in FIG. 2B, the resin composition 2a is provided on the transparent base material 1 by lowering the ejector 5 to bring the mold 4 closer to the transparent base material 1 (provision step). The resin composition is molded into a desired shape by further lowering the ejector 5 and filling the space between the mold 4 and the transparent base material 1 with the uncured resin composition 2a (molding step).

Further, the resin composition 2a is irradiated with ultraviolet rays from the second surface 1B side of the transparent base material 1 using an ultraviolet light source 6 to polymerize or copolymerize the resin composition 2a, thereby obtaining the cured product 2 which is a polymerized and cured product (curing step, light irradiation step).

Thereafter, the cured product 2 that has been polymerized and cured is released from the mold 4 to obtain the optical element 10 having the cured product 2 with an aspherical shape on the transparent base material 1 as shown in FIG. 1. Further, the cured product 2 is formed and then may be additionally irradiated with ultraviolet rays or subjected to a heat treatment in the atmosphere or in an oxygen-free environment.

The optical element of the present disclosure can be produced by the above-described production method. Further, in the provision step, the resin composition 2a may be added dropwise to both the mold 4 and the transparent base material 1 or only to the transparent base material 1. Further, the light irradiation step may be changed to a heat treatment step when the resin composition 2a contains a thermal polymerization initiator as the polymerization initiator. Further, only the cured product 2 may be used as the optical element 10 by peeling the transparent base material 1 off from the optical element 10 after the curing step.

### Optical Device

Specific application examples of the optical element of the embodiment described above include lenses constituting optical devices (photographic optical systems) for cameras and video cameras and lenses constituting optical devices (projection optical systems) for liquid crystal projectors. Further, the optical element described above can also be used as pickup lenses of DVD recorders and the like. These optical devices have a housing and at least one lens disposed in the housing, and the optical element of the present embodiment can be used as this at least one lens.

### Imaging Device

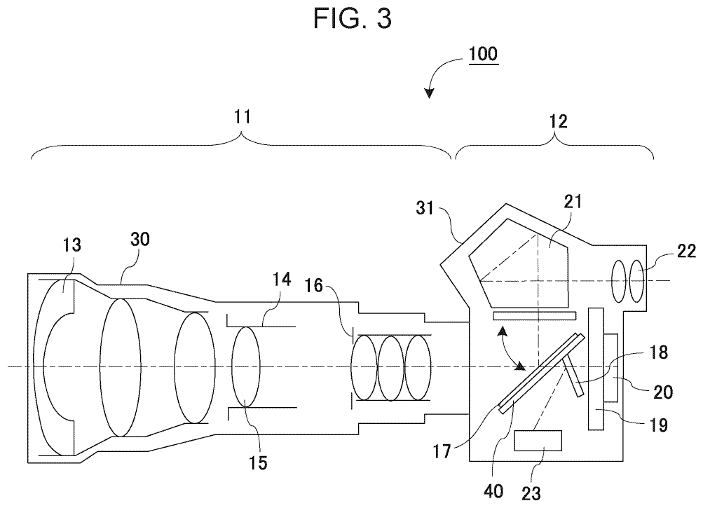

FIG. 3 is a schematic view showing an imaging device according to an embodiment of the present disclosure, and is also a schematic view showing a configuration of a single-lens reflex digital camera 100, which is an example of a suitable embodiment of an imaging device including the optical element according to the embodiment described above. The imaging device according to the present embodiment may include a housing, an optical system having at least one lens disposed in the housing, and an imaging element that receives light having passed through the optical system. In FIG. 3, a camera main body 12 is coupled to a lens barrel 11 serving as an optical device, and the lens barrel 11 is a so-called interchangeable lens that is detachably attached to the camera main body 12.

Light from a subject is photographed via an optical system formed of a plurality of lenses 13, 15, and the like arranged on an optical axis of the photographic optical system in a housing 30 of the lens barrel 11. This optical element can be used, for example, as the lens 13 and 15. Here, the lens 15 is supported by an inner barrel 14, and is movably supported relative to an outer barrel of the lens barrel 11 for focusing or zooming.

In the observation period before photographing, light from the subject is reflected by a main mirror 17 in the housing 31 of the camera main body and passes through a prism 21, and a photographed image is projected to a photographer through a finder lens 22. The main mirror 17 is, for example, a half mirror, the light having transmitted through the main mirror 17 is reflected by a sub-mirror 18 in a direction of an autofocus (AF) unit 23, and this reflected light is used, for example, for ranging. Further, the main mirror 17 is mounted on and supported by a main mirror holder 40 by adhesion or the like. The main mirror 17 and the sub-mirror 18 are moved to the outside of an optical path through a driving mechanism (not shown) during photographing, a shutter 19 is opened, and the imaging element 20 receives light having transmitted through the photographic optical system after entrance from the lens barrel 11 to form a photographic light image. Further, a diaphragm 16 is configured to change the brightness or depth of focus during photographing by changing the aperture area.

Here, the imaging device has been described using a single-lens reflex digital camera, but can be similarly used in smartphones, compact digital cameras, drones, and the like.

### EXAMPLES

Hereinafter, the present disclosure will be described with reference to examples and comparative examples.

### Compound

Compounds used in the examples and the comparative examples are as follows.

Component (A): urethane (meth)acrylate
A-1:polycarbonate-based bifunctional urethane acrylate (Mw: 15,000) (“ART RESIN UN-9200A”, manufactured by Negami Chemical Industrial Co., Ltd.)
A-2:polycarbonate-based bifunctional urethane acrylate (Mw: 5,000) (“ART RESIN UN-9000PEP”, manufactured by Negami Chemical Industrial Co., Ltd.) Component (B): monofunctional (meth)acrylate
B-1: dicyclopentamethacrylate (“FA-513M”, manufactured by Resonac Holdings Corporation)
B-2: dicyclopentenyloxyethyl methacrylate (“FA-512M”, manufactured by Resonac Holdings Corporation)
B-3: isobornyl acrylate (“IB-XA”, manufactured by KYOEISHA CHEMICAL CO., LTD.)
Monomer of component (C): monofunctional (meth)acrylate monomer (c1) c-1: dicyclopentamethacrylate (“FA-513M”, manufactured by Resonac Holdings Corporation)
c-2: dicyclopentenyloxyethyl methacrylate (“FA-512M”, manufactured by Resonac Holdings Corporation)
   Component (D): polymerization initiator
D-1:1-hydroxycyclohexyl phenyl ketone (“Omnirad 184”, manufactured by IGM Resins B. V., photopolymerization initiator)

### Example 1

### Preparation of Component (C)

100 parts by mass of a compound “C-1” as a monofunctional (meth)acrylate monomer (c1) was mixed with 100 parts by mass of toluene, and the mixture was mixed with 1 part by mass of AIBN (2,2′-azobis(isobutyronitrile), manufactured by Tokyo Chemical Industry Co., Ltd.). Thereafter, the mixture was heated at 60° C. for 6 hours while being bubbled with nitrogen gas, purified by reprecipitation with 1,000 parts by mass of methanol, filtered, and dried in a vacuum, thereby obtaining a component (C). The weight-average molecular weight (Mw) of the component (C) was 173,000 in terms of polymethyl methacrylate.

### Preparation of Resin Composition

63 parts by mass of a compound “A-1” as a component (A), 25 parts by mass of a compound “B-1” as a component (B), 10 parts by mass of the component (C) prepared above, and 2 parts by mass of a compound “D-1” as a component (D) were put into a bottle and uniformly mixed, thereby obtaining a resin composition.

### Production of Optical Element

The optical element shown in FIG. 1 was produced using the production method shown in FIGS. 2A and 2B. Optical glass (S-TIM8, manufactured by Ohara Corporaiton) having a diameter of 32 mm was prepared as the transparent base material 1. The transparent base material 1 has one surface (first surface 1A) in a concave spherical shape with a radius of 40 mm and the other surface (second surface 1B) in a convex spherical shape with a radius of 75 mm. A mold obtained by cutting a NiP layer plated on a metal parent material with a precision working machine to form an inverted shape of the aspherical shape of the cured product 2 as a molding target was used as the mold 4.

Next, the space between the transparent base material 1 and the mold 4 was filled with the resin composition 2a. Thereafter, the entire surface of the resin composition 2a was irradiated with ultraviolet rays having a wavelength of 365 nm at an intensity of 10 mW/cm² from the ultraviolet light source 6 for 200 seconds in order to cure the resin composition 2a. The mold 4 was released from the transparent base material 1, and the transparent base material 1 was heated at 80° C. for 24 hours to form the cured product 2 on the first surface 1A of the transparent base material 1, thereby obtaining the optical element 10.

### Evaluation

The resin composition and the optical element were evaluated as follows. The results thereof are listed in Table 1.

### Water Absorbency Test

A cured product was prepared from the resin composition by the method described below. First, a metal mold having a length of 60 mm, a width of 60 mm, and a thickness of 1 mm was sandwiched between two sheets of quartz glass, and the resin composition was poured into the mold.

The entire surface of the resin composition that had been poured into the mold was irradiated with ultraviolet rays having a wavelength of 405 nm at an intensity of 10 mW/cm² for 200 seconds. The obtained cured product was heated at 80° C. for 24 hours, thereby obtaining a test piece having a length of 60 mm, a width of 60 mm, and a thickness of 1 mm. The value obtained by weighing the test piece after drying the test piece at 50° C. for 24 hours was defined as DO (g), and the value obtained by weighing the test piece after immersing the test piece in water at 23° C. for 24 hours and wiping the moisture on the surface thereof was defined as D1 (g), and the water absorption rate was calculated using the following equation.

Water absorption rate[%]=((D1−D0)/D0)×100

### Temperature Cycle Test

The temperature cycle test was performed by placing the optical element in a thermostatic bath and cycling between temperatures of −30° C. and 60° C. for 100 cycles, the presence or absence of cracks was confirmed after the test, and the evaluation was performed according to the following criteria.
A: Cracks did not occur.
B: Cracks occurred.

### Compatibility

After the preparation of the resin composition, the resin composition was allowed to stand at 23° C. for 24 hours, and the compatibility thereof was evaluated according to the following criteria.
A: The resin composition after the standing was uniform and compatible.
B: The resin composition was uniformly compatible when heated at 70° C. after the standing.

### Examples 2 to 5 and Comparative Examples 1 and 2

Resin compositions and optical elements were prepared in the same manner as in Example 1 except that the type of each component and the amount thereof were changed as listed in Table 1, and evaluations were performed in the same manner as in Example 1. The evaluation results thereof are listed in Table 1.

TABLE 1

| | | | | | | | Comparative | |
|---|---|---|---|---|---|---|---|---|
| | | Example | | | | | Example | |
| | | 1 | 2 | 3 | 4 | 5 | 1 | 2 |
| Component | Type | A-1 | A-1 | A-2 | A-1 | A-2 | A-1 | A-1 |
| (A) | Content | 63 | 63 | 63 | 65 | 60 | 60 | 70 |
| | [parts by mass] | | | | | | | |
| Component | Type | B-1 | B-3 | B-1 | B-2 | B-2 | B-3 | B-3 |
| (B) | Content | 25 | 25 | 30 | 30 | 23 | 38 | 28 |
| | [parts by mass] | | | | | | | |
| Component | Type of | c-1 | c-1 | c-1 | c-2 | c-2 | — | — |
| (C) | monomer | | | | | | | |
| | Content | 10 | 10 | 5 | 3 | 15 | 0 | 0 |
| | [parts by mass] | | | | | | | |
| | Mw | 17,300 | 17,300 | 17,300 | 90,000 | 90,000 | — | — |
| Component | Type | D-1 | D-1 | D-1 | D-1 | D-1 | D-1 | D-1 |
| (D) | Content | 2 | 2 | 2 | 2 | 2 | 2 | 2 |
| | [parts by mass] | | | | | | | |

| | | | | | | | |
|---|---|---|---|---|---|---|---|
| Moisture content [%] | 0.29 | 0.32 | 0.35 | 0.41 | 0.24 | 0.31 | 0.55 |
| Temperature cycle test | A | A | A | A | A | B | A |
| Compatibility | A | B | A | A | B | A | A |

As listed in Table 1, in all Examples 1 to 5 in which the resin composition contained the component (A), the component (B), and the component (C), and the content of the component (C) was 15 parts by mass or less, the water absorption rate was 0.50% or less, cracks did not occur in the temperature cycle test, and the compatibility was also satisfactory. In the comparative examples, since the resin composition did not contain the component (C), it was difficult to achieve both the toughness (no cracks in the temperature cycle test) and the low water absorption rate (water absorption rate of 0.50% or less). The results of evaluation of the compatibility were different between Examples 1 and 2 due to the different types of the component (B), and the compatibility of Example 1 was more satisfactory. Based on the results, it was found that more satisfactory compatibility was exhibited when the compound “C-1” as a monomer of the component (C) of Example 1 was the same as the compound “B-1” as the component (B) of Example 1.

As described above, according to the resin composition of the present disclosure, it is possible to provide an optical element that achieves both the toughness and the low water absorption rate.

### Included Configurations

The present embodiment of the present disclosure includes the following configurations.

### Configuration 1

A resin composition including: a urethane (meth)acrylate (A); a monofunctional (meth)acrylate (B) having an alicyclic skeleton represented by any of Formulae (1) to (3); and a polymer (C) of a monofunctional (meth)acrylate monomer (c1) having an alicyclic skeleton represented by any of Formulae (1) to (3), in which a content of the polymer (C) is 15 parts by mass or less with respect to 100 parts by mass of the resin composition.

### Configuration 2

A resin composition including: a urethane (meth)acrylate (A); a monofunctional (meth)acrylate (B) having an alicyclic skeleton represented by any of Formulae (1) to (3); and a polymer (C) of a monofunctional (meth)acrylate monomer (c1) having an alicyclic skeleton represented by any of Formulae (1) to (3), in which a cured product of the resin composition has a water absorption rate of 0.50% or less.

### Configuration 3

The resin composition according to the configuration 1 or 2, in which the urethane (meth)acrylate (A) has an alicyclic skeleton.

### Configuration 4

The resin composition according to any one of the configurations 1 to 3, in which the urethane (meth)acrylate (A) is a reactant of a diisocyanate having an alicyclic skeleton, a diol, and a hydroxyl group-containing (meth)acrylate.

### Configuration 5

The resin composition according to any one of the configurations 1 to 4, in which the urethane (meth)acrylate (A) is a bifunctional urethane (meth)acrylate.

### Configuration 6

The resin composition according to any one of the configurations 1 to 5, in which the monofunctional (meth)acrylate (B) is a compound represented by any of Formulae (1a) to (3a).

### Configuration 7

The resin composition according to any one of the configurations 1 to 6, in which the monofunctional (meth)acrylate monomer (c1) is the same compound as the monofunctional (meth)acrylate (B).

### Configuration 8

The resin composition according to any one of the configurations 1 to 7, in which the monofunctional (meth)acrylate monomer (c1) is a compound represented by any of Formulae (1a) to (3a).

### Configuration 9

The resin composition according to any one of the configurations 1 to 8, in which the polymer (C) has a weight-average molecular weight of 35,000 or greater and 300,000 or less.

### Configuration 10

The resin composition according to any one of the configurations 1 to 9, further including: a polymerization initiator (D).

### Configuration 11

An optical element including: a transparent base material; and a cured product of the resin composition according to any one of the configurations 1 to 10, which is provided on the transparent base material.

### Configuration 12

The optical element according to the configuration 11, in which the transparent base material has a first surface having a concave spherical shape, and the cured product is provided on the first surface.

### Configuration 13

The optical element according to the configuration 11 or 12, in which a ratio of a maximum thickness d2 to a minimum thickness d1 of the cured product is greater than 1 and 30 or less.

### Configuration 14

The optical element according to the configuration 13, in which the minimum thickness d1 is 300 μm or less, and the maximum thickness d2 is 10 μm or greater and 1,000 μm or less.

### Configuration 15

An optical device including: a housing; and an optical system that has at least one lens disposed in the housing, in which the at least one lens is the optical element according to any one of the configurations 11 to 14.

### Configuration 16

An imaging device including: a housing; an optical system that has at least one lens disposed in the housing; and an imaging element that receives light having passed through the optical system, in which the at least one lens is the optical element according to any one of the configurations 11 to 14.

### Configuration 17

A cured product that is obtained by curing the resin composition according to any one of the configurations 1 to 10.

### Configuration 18

A method of producing the resin composition according to any one of the configurations 1 to 10, the method including: a polymerization step of polymerizing the monofunctional (meth)acrylate monomer (c1) to produce a polymer (C); and a mixing step of mixing the polymer (C), the urethane (meth)acrylate (A), and the monofunctional (meth)acrylate (B).

### Configuration 19

A method of producing an optical element, including: a preparation step of preparing a transparent base material, and the resin composition according to any one of the configurations 1 to 10; a provision step of providing the resin composition on the transparent base material; and a curing step of polymerizing or copolymerizing the resin composition to form a cured product.

### Configuration 20

The method of producing an optical element according to the configuration 19, in which the provision step includes a molding step of molding the resin composition using a mold.

### Configuration 21

The method of producing an optical element according to the configuration 20, in which the curing step includes a light irradiation step of polymerizing or copolymerizing the resin composition by irradiation with light.

According to the above-described aspects, it is possible to provide a resin composition that achieves both the toughness and the low water absorption rate, and a cured product thereof. Further, it is possible to provide an optical element formed of the cured product thereof.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033069, filed Mar. 3, 2025, which is hereby incorporated by reference herein in its entirety.

What is claimed is:

1. A resin composition comprising:
a urethane (meth)acrylate (A);
a monofunctional (meth)acrylate (B) having an alicyclic skeleton represented by any of Formulae (1) to (3); and
a polymer (C) of a monofunctional (meth)acrylate monomer (c1) having an alicyclic skeleton represented by any of Formulae (1) to (3),
wherein a content of the polymer (C) is 15 parts by mass or less with respect to 100 parts by mass of the resin composition.

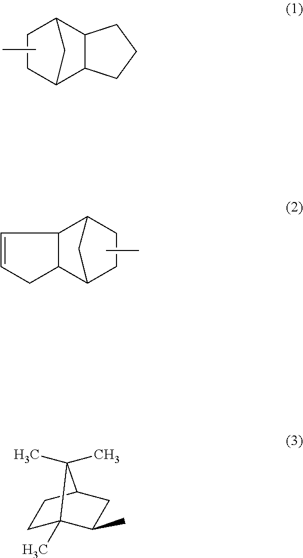

2. The resin composition according to claim 1,
wherein the urethane (meth)acrylate (A) has an alicyclic skeleton.

3. The resin composition according to claim 1,
wherein the urethane (meth)acrylate (A) is a reactant of a diisocyanate having an alicyclic skeleton, a diol, and a hydroxyl group-containing (meth)acrylate.

4. The resin composition according to claim 1,
wherein the urethane (meth)acrylate (A) is a bifunctional urethane (meth)acrylate.

5. The resin composition according to claim 1,
wherein the monofunctional (meth)acrylate (B) is a compound represented by any of Formulae (1a) to (3a), 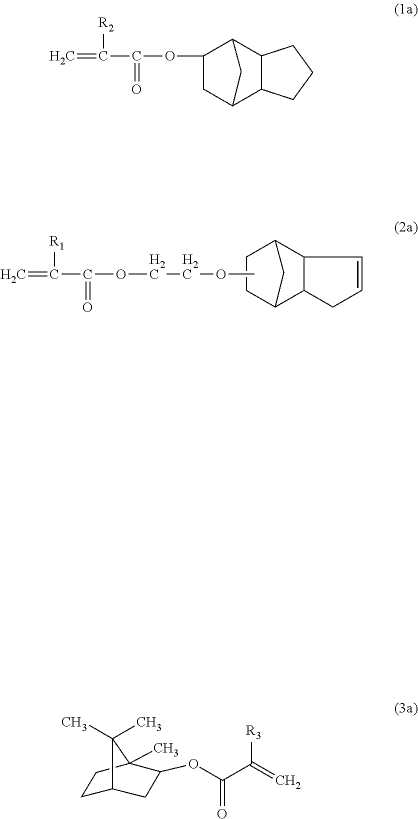
in Formulae (1a) to (3a), R₁ to R₃ represent a hydrogen atom or a methyl group.

6. The resin composition according to claim 1,
wherein the monofunctional (meth)acrylate monomer (c1) is the same compound as the monofunctional (meth)acrylate (B).

7. The resin composition according to claim 1,
wherein the monofunctional (meth)acrylate monomer (c1) is a compound represented by any of Formulae (1a) to (3a), 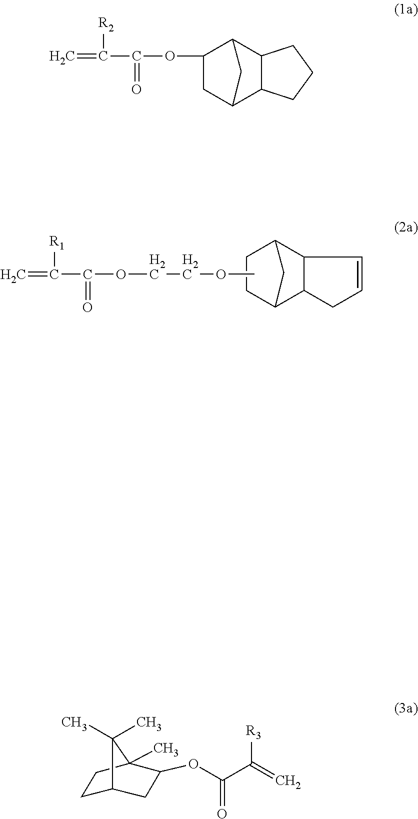
in Formulae (1a) to (3a), R₁ to R₃ represent a hydrogen atom or a methyl group.

8. The resin composition according to claim 1,
wherein the polymer (C) has a weight-average molecular weight of 35,000 or greater and 300,000 or less.

9. The resin composition according to claim 1, further comprising:
a polymerization initiator (D).

10. An optical element comprising:
a transparent base material; and
a cured product of the resin composition according to claim 1, which is provided on the transparent base material.

11. The optical element according to claim 10,
wherein the transparent base material has a first surface having a concave spherical shape, and
the cured product is provided on the first surface.

12. The optical element according to claim 10,
wherein a ratio of a maximum thickness d2 to a minimum thickness d1 of the cured product is greater than 1 and 30 or less.

13. The optical element according to claim 12,
wherein the minimum thickness d1 is 300 μm or less, and the maximum thickness d2 is 10 μm or greater and 1,000 μm or less.

14. An optical device comprising:
a housing; and
an optical system that has at least one lens disposed in the housing,
wherein the at least one lens is the optical element according to claim 10.

15. An imaging device comprising:
a housing;
an optical system that has at least one lens disposed in the housing; and
an imaging element that receives light having passed through the optical system,
wherein the at least one lens is the optical element according to claim 10.

16. A cured product that is obtained by curing the resin composition according to claim 1.

17. A method of producing the resin composition according to claim 1, the method comprising:
polymerizing the monofunctional (meth)acrylate monomer (c1) to produce a polymer (C); and
mixing the polymer (C), the urethane (meth)acrylate (A), and the monofunctional (meth)acrylate (B).

18. A method of producing an optical element, comprising:
preparing a transparent base material, and the resin composition according to claim 1;
providing the resin composition on the transparent base material; and
polymerizing or copolymerizing the resin composition to form a cured product.

19. The method of producing the optical element according to claim 18,
wherein the providing of the resin composition includes molding the resin composition using a mold.

20. A resin composition comprising:
a urethane (meth)acrylate (A);
a monofunctional (meth)acrylate (B) having an alicyclic skeleton represented by any of Formulae (1) to (3); and
a polymer (C) of a monofunctional (meth)acrylate monomer (c1) having an alicyclic skeleton represented by any of Formulae (1) to (3),
wherein a cured product of the resin composition has a water absorption rate of 0.50% or less. [chemical structure]
